(19) United States
(12) Patent Application Publication
(10) Pub. No.: US 2018/0098606 A1
(43) Pub. Date: Apr. 12, 2018

(54) Environmentally-Friendly Bags and Totes

(71) Applicant: Betty Ann Hoying, Fort Wayne, IN (US)

(72) Inventor: Betty Ann Hoying, Fort Wayne, IN (US)

(21) Appl. No.: 15/695,663

(22) Filed: Sep. 5, 2017

Related U.S. Application Data
(60) Provisional application No. 62/406,755, filed on Oct. 11, 2016.

(51) Int. Cl. A45C 3/04; B32B 5/26; A45C 13/02

(52) U.S. Cl. CPC A45C 3/04; B32B 5/26; B32B 2307/7163; B32B 2250/20; A45C 13/02

(57) ABSTRACT

An environmentally-friendly bag comprising panels and seams. The panels consist essentially of a side panel and a bottom panel. The seams comprise a side seam and a bottom seam.

### CROSS REFERENCE TO RELATED APPLICATIONS

This application claims the benefit of U.S. provisional patent application Ser. No. 62/406,755, filed 2016 Oct. 11, by Hoying, and having the title “Environmentally-Friendly Bags and Totes,” which is incorporated herein by reference in its entirety.

### BACKGROUND

### Field of the Disclosure

The present disclosure relates generally to bags and, more particularly, to bags and totes manufactured from materials that are environmentally friendly.

### Description of Related Art

Bags and totes are known in the art. For example, when shopping for groceries, a shopper is provided with an option for a paper bag or a plastic bag. Plastic bags are harmful to the environment, while paper bags are not durable. In addition to grocery bags, there are other types of bags and totes that are manufactured from cotton or nylon. However, similar to plastic, nylon bags are not very environmentally-friendly (or eco-friendly). Consequently, there are ongoing efforts to improve manufacturing of bags and totes.

### SUMMARY

One embodiment of the invention is a bag comprising panels and seams. The panels consist essentially of a side panel and a bottom panel. The seams comprise a side seam and a bottom seam.

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a drawing showing one embodiment of an environmentally-friendly bag.

FIG. 2 is a drawing showing another embodiment of an environmentally-friendly bag.

FIG. 3 is a drawing showing one embodiment of panels that are used to manufacture the bag of FIG. 1.

FIG. 4 is a drawing showing one embodiment of panels that are used to manufacture the bag of FIG. 2.

FIG. 5 is a drawing showing a bottom view of the bag of FIG. 1.

FIG. 6 is a drawing showing a bottom view of the bag of FIG. 2.

FIG. 7 is a drawing showing a front view of the bag of FIG. 1.

FIG. 8 is a drawing showing a side seam and a rear view of the bag of FIG. 1.

FIG. 9 is a drawing showing a top view of the bag of FIG. 1 without a cuff.

FIG. 10 is a drawing showing a top view of the bag of FIG. 1 with a cuff.

### DETAILED DESCRIPTION OF THE EMBODIMENTS

Conventionally, grocery bags are manufactured from either paper or plastic. Unfortunately, plastic bags are harmful to the environment (not eco-friendly), while paper bags are not durable. Although other types of bags and totes manufactured from cotton or nylon exist, none of these types of bags are manufactured specifically to be eco-friendly.

To remedy this need in the art, this disclosure provides for a washable paper bag that is manufactured from an eco-friendly paper material. Thus, unlike conventional paper bags (which cannot be washed), the disclosed embodiments of the inventive bag are more durable. Also, unlike conventional plastic or nylon bags (which are not eco-friendly), the disclosed embodiments of the bags manufactured from compostable paper materials are eco-friendly.

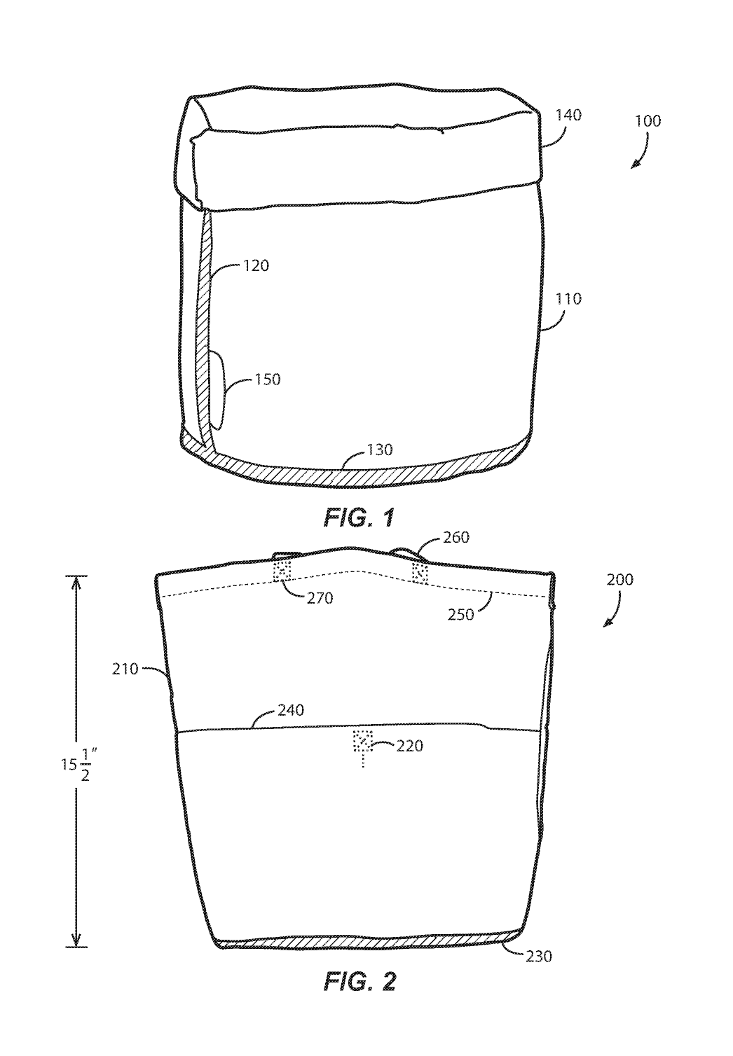

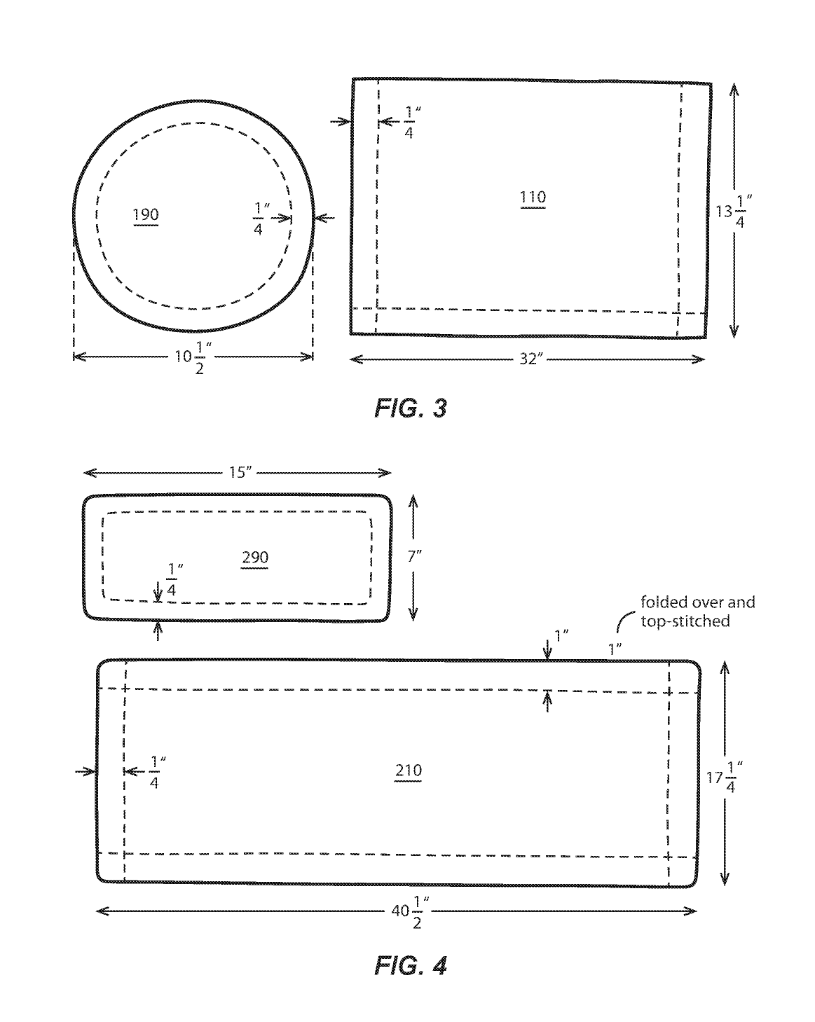

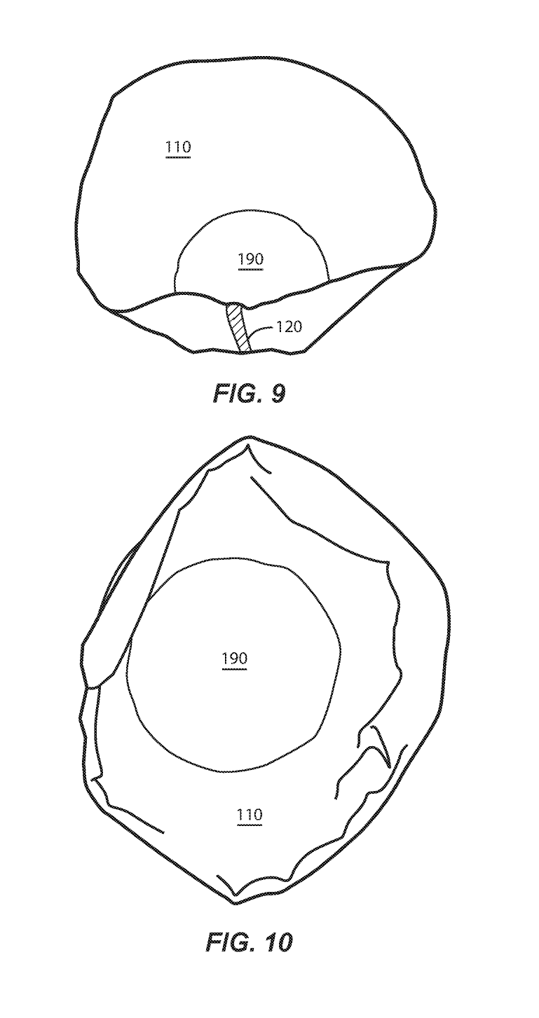

Having provided a general solution, reference is now made in detail to the description of the embodiments as illustrated in the drawings. Specifically, FIGS. 1, 5, 7, 8, 9, and 10 are drawings showing one embodiment of an environmentally-friendly bag 100, while FIG. 3 shows an embodiment of panels that are used to manufacture the bag 100 of FIGS. 1, 5, 7, 8, 9, and 10. Also, FIGS. 2 and 6 are drawings showing another embodiment of an environmentally-friendly bag 200, while FIG. 4 show an embodiment of panels that are used to manufacture the bag 200 of FIGS. 2 and 6. To distinguish between the different embodiments that are disclosed herein, the environmentally-friendly bag 100 of FIGS. 1, 3, 5, 7, 8, 9, and 10 is also designated herein as a “bucket” 100, while the environmentally-friendly bag 200 of FIGS. 2, 4, and 6 is also designated herein as “tote” 200.

As shown in FIGS. 1, 5, 7, 8, 9, and 10, the bucket 100 is a washable paper bag 100 that is made of an environmentally-friendly (or eco-friendly) paper material. For some embodiments, the paper material is Kratf-tex® paper, T484 (from Texon International Group, LTD, which is used for labels that are sewn onto denim in the apparel industry) or other material that is derived from natural pulp fibers that are bonded with polymers. The polymer bonding makes the materials eco-friendly, durable, sewable (or stitchable), and washable.

Preferably, the bucket 100 is hand made. However, mass production or other manufacturing processes can be used to manufacture the bucket 100. Because the starting materials for the eco-friendly bucket 100 is lightweight, durable, and machine washable, the resulting bucket 100 is likewise eco-friendly, lightweight, durable, and machine washable. Additionally, the bucket 100 is easily customizable with stamping, drawing, painting, or other known processes.

As shown in FIG. 3, the starting materials for the eco-friendly bucket 100 comprises washable paper panels consisting essentially of a side panel 110 and a bottom panel 190. The bottom panel 190 has a substantially circular shape, while the side panel 110 has a substantially rectangular shape. In a preferred embodiment, the substantially-circular bottom panel 190 is approximately 10.5 inches in diameter, with an allowance of approximately 0.25 inches along its perimeter for stitching (shown as a broken line). The substantially-rectangular side panel 110 comprises two side edges, a top edge, and a bottom edge, with the side edges being approximately 13.25 inches in height with a 0.25 inch allowance for stitching and the top and bottom edges are approximately 32 inches in length with a 0.25 inch allowance for stitching. Either prior to assembly or after assembly, the panels 110, 190 are washed, thereby resulting in some shrinkage of the materials and, thus, a slight reduction in the dimensions of the final assembled bucket 100.

The two side edges of the side panel 110 are stitched together to form a substantially-cylindrical shape. As explained in greater detail below, the seam is stitched on the outside of the bucket 100 (without turning inside-out to hide the stitching). Preferably, 40 denier polyester is used for stitching, though it should be appreciated that other similar thread can be used in place of the 40 denier polyester. For some embodiments, an optional label 150 can be stitched to the side panel 110 during the stitching of the side edges. In a preferred embodiment, a visible seam that is created by the stitching of the side edges (also designated herein as “side seam”) is covered by a bias tape 120 or other equivalent structure (also designated herein as “side bias tape”).

Conventional wisdom teaches that increasing stitch count (or increasing density of the stitches) results in a corresponding increase in strength at the seams. However, manufacture of the eco-friendly bucket 100 proceeds contrary to conventional wisdom by reducing the stitch count. This is because, unlike cloth or nylon materials (which are not compostable), the eco-friendly bucket 100 comprises compostable, natural pulp fibers. Consequently, if the stitch count (or density of stitches) is too high for the bucket 100, then the holes that are created by the stitching cause a perforation that manifests itself as a vulnerability in the structural strength of the bucket 100. Thus, rather than increasing stitch count (as typically taught in conventional processes), the eco-friendly bucket 100 employs no more than eight (8) stitches per inch (SPI) and, preferably, no more than seven (7) SPI. It should be noted that reducing the stitch count too far results in larger gaps, which can be unsightly and cause other structural problems. Consequently, the 7 SPI to 8 SPI stitch count is not merely an arbitrary choice, but a functional consideration that affects the structural integrity of the eco-friendly bucket 100.

After stitching together the side edges, the substantially-cylindrical side panel 110 is stitched to the substantially-circular bottom panel 190 to form the bucket 100. Similar to the side seam, a visible bottom seam results from the stitching of the side panel 110 with the bottom panel 190. Preferably, the bottom seam is covered by bias tape 130 (designated herein as “bottom bias tape”).

Returning to FIG. 3, from a manufacturing standpoint, once designs and patterns are finalized, the materials are cut to size using, preferably, an industrial cutter. The industrial cutter concurrently cuts through multiple layers of the eco-friendly material. For some embodiments, any excess paper (left after cutting) is used to create the labels 150 for the bucket 100. For example, the excess paper is cut down to two-inch-by-one-inch (2″×1″) rectangles and stamped with a logo (e.g., “BSIMPLE™”) or a design. For other embodiments, pre-cut slip pockets are made from the excess paper, which are sewn onto the inside of each bucket 100.

Summarizing the manufacture of the bucket 100, first, the raw materials (e.g., Kratf-tex® paper, T484 (from Texon International Group, LTD, which is used for labels that are sewn onto denim in the apparel industry) or other material that is derived from natural pulp fibers that are bonded with polymers) are acquired. Second, optionally, the raw materials are pre-washed. Third, the materials are cut to their proper sizes and shapes based on desired designs and patterns, with the end result being the side panel 110 and the bottom panel 190. Fourth, optionally, labels are created from any excess materials (which remain after cutting of the panels). Fifth, side edges of the side panel 110 are stitched together to form a substantially-cylindrical structure 110. Sixth, optionally, a label 150 is attached to the bucket 100. Seventh, the stitched side (along with the stitching on the optional label) is covered with a bias tape 120. Eighth, the substantially-cylindrical structure 110 is stitched at its bottom to the bottom panel 190. Ninth, the stitched bottom is covered with bias tape 130.

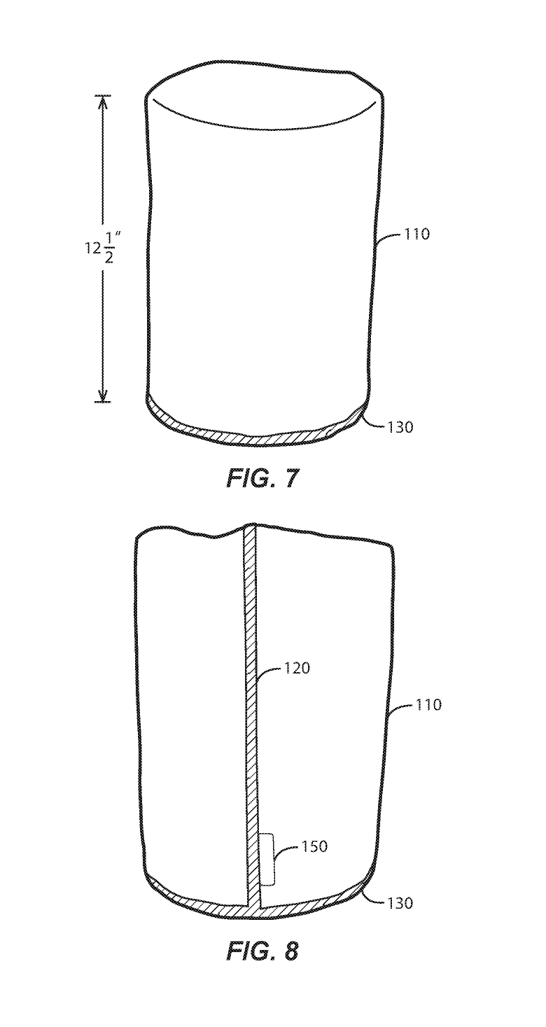

Next (and approximately tenth step in the process), at random intervals a quality control inspection is performed to make sure that the seams are sewn straight and that the side-seam stitching is completely covered by the bias tape 120, 130. The quality control also checks to make sure that there are no holes or tears in any of the seams or in the panels 110, 190. Furthermore, the quality inspection checks for loose threads, makes sure that any slip pockets or side labels are sewn straight and are facing the right direction, etc. Eleventh, following inspection, the bucket 100 is washed using a commercial washing machine, using a regular cycle in warm water with mild or no detergent. The washing process after assembly substantially guarantees that any shrinkage, which may occur, affects the whole, assembled product. Thus, washing after assembly keeps shrinkage to a minimum and has less impact on the sewing or the shape of the bucket 100. Furthermore, washing a finished bucket 100 softens it and gives it a finish that is oftentimes more user friendly and attractive. Twelfth, after washing, the bucket 100 is dried using a commercial (or standard) dryer for a short period (e.g., five (5) minutes to ten (10) minutes) to remove excess moisture but to maintain dampness. This is because a damp bucket 100 is easier to reshape, roll, or cuff. Thirteenth, optionally, the bucket 100 is rolled or folded at the top to create a cuff 140 (FIGS. 1 and 10). It should be appreciated that the cuff 140 is optional and, thus, can later be unrolled (as shown in FIGS. 7, 8, and 9). Lastly, upon finally shaping the bucket 100, it is hung to air dry, thereby resulting in the final product.

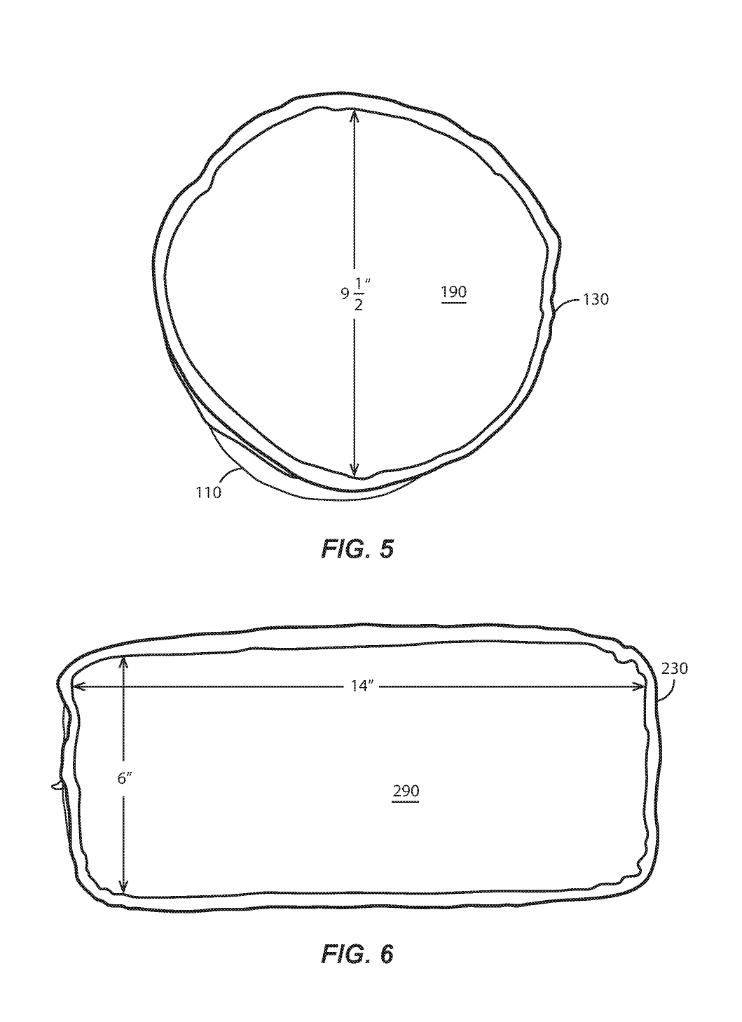

Because of the 0.25 inch allowance for stitching and, also, the shrinkage that results from the manufacturing process, the final eco-friendly bucket 100 has a bottom diameter of approximately 9.5 inches (FIG. 5) and a height of approximately 12.5 inches (FIG. 7).

It should be appreciated that, although an example manufacturing process is described with reference to the bucket 100, a corresponding process is applicable to the tote 200 (FIGS. 2, 4, and 6). Furthermore, although various features of the bucket 100 are described in detail, above, it should be appreciated that similar features are also present in the tote 200. With this in mind, attention is turned to FIGS. 2, 4, and 6, which show various embodiments of the tote 200. Additionally, even though the manufacturing process is described sequentially for purposes of clarity, it should be appreciated that several of the manufacturing process steps can be taken out of order without materially affecting the production of the bucket 100 or the tote 200.

As shown in FIGS. 2 and 6, the tote 200 is a washable paper bag 200 that is made of an environmentally-friendly (or eco-friendly) paper material. Similar to the bucket 100, the tote is manufactured using Kratf-tex® paper, T484 (from Texon International Group, LTD, which is used for labels that are sewn onto denim in the apparel industry) or other material that is derived from natural pulp fibers that are bonded with polymers, which makes the materials eco-friendly, durable, sewable (or stitchable), and washable. Preferably, the tote 200 is also hand made, but mass production or other manufacturing processes can be used. Because if its starting materials, the tote 200 is lightweight, durable, machine washable, and easily customizable with stamping, drawing, painting, or other known processes.

As shown in FIG. 4, the starting materials for the eco-friendly tote 200 comprises washable paper panels consisting essentially of a side panel 210 and a bottom panel 290. Both the bottom panel 290 and the side panel have substantially rectangular shapes. In a preferred embodiment, the bottom panel 290 is approximately 15 inches-by-7 inches, with an allowance of approximately 0.25 inches along its perimeter for stitching (shown as a broken line). The side panel 210 is approximately 40.5 inches-by-17.25 inches, again with a 0.25 inch allowance for stitching. The side panel 210 and the bottom panel 290 are assembled in a manner similar to how the bucket 100 was assembled (as described above). However, because the bottom panel 290 is substantially rectangular, the shape of the tote 200 is closer to the shape of a conventional tote, rather than the shape of the bucket 100.

Unlike the bucket 100, the tote 200 comprises a pocket 240 that is created by sewing an outer panel to the outside of the side panel 210. The pocket 240 comprises a fastener 220 (e.g., hook-and-loop (such as Velcro®), a box stitch, a top stitch, etc.) to close the pocket to some extent. Additionally, the tote 200 comprises handles 260, which are box-stitched 270 to the tote 200 at its top. To accommodate the box-stitches 270, the top of the tote is folded over (at about an inch from the top) and top-stitched 250 (FIG. 4) to reinforce the top and accommodate the box-stiches 270. Because of the 0.25 inch allowance for stitching and, also, the shrinkage that results from the manufacturing process, the final eco-friendly tote 200 has a bottom dimension of approximately 6 inches-by-14 inches (FIG. 6) and a height of approximately 15.5 inches (FIG. 2).

In sum, when finally assembled, the tote 200 comprises a side panel 210 that is stitched to a bottom panel 290, with bias tape 230 covering the resulting seam. The tote 200 also comprises an outer pocket 240, which closes with a fastener 220 (such as a box stitch). Furthermore, the top of the tote 200 is folded over and top stitched 250 to accommodate handles 260, which are secured to the tote 200 by a set of box-stitches 270. As with the bucket 100, the stitch count for the tote 200 is less than 8 STI and, more preferably, around 7 STI, thereby avoiding a perforation that affects the structural integrity of the tote.

Because of the unique quality and capabilities of the underlying paper material, the bags 100, 200 are designed with six (6) main construction features.

The first feature is that the bags 100, 200 are designed with a streamlined profile that allows for minimal stitching. For example, only a side seam and a bottom seam are used for the bucket 100. Because of the natural characteristics of paper, once punctured with needles or pins, any holes become permanent. Thus, similar to perforated paper envelopes, any holes in the paper make the paper easier to tear or rip. Furthermore, the holes are more visible on the paper materials than in cloth materials. With this in mind, the bucket 100 is designed with only two (2) primary pieces: (a) a long rectangular first piece that is wrapped around and sewn on one (1) side 110 to create a cylindrical body; and (b) a circular bottom 190, which is sewn to the bottom of the cylindrical piece to form the bottom of the bucket 100. For larger embodiments of the bag 100, 200, three (3) pieces are used in construction, rather than two (2) pieces. Preferably, the third piece provides a color-blocked design element by layering a different color piece of paper on top of the primary piece. Stitching both pieces together on top of each other provides greater strength and stability to the final product.

The second feature is that there is no turning during construction. Typically, when bags or garments are made, the pattern pieces are sewn together on the wrong side (or side that is eventually hidden from view) and then turned inside out after sewing is completed. This allows for the unfinished part of the seam to be on the inside of the garment or bag. In contrast to this conventional wrong-side sewing, the inventive embodiments avoid manual turning for several reasons. First, turning is time consuming and increases labor costs. Second, turning puts undue stress on the stitched seams before the bag 100, 200 is finished. Third, turning leaves the paper materials with a crinkled or scrunched finish, which may or may not come out in the washing process, thereby detracting from the aesthetics of the bag 100, 200. Consequently, the bags 100, 200 are intentionally designed so that all of the sewing is done on the outside of the bag 100, 200, thereby avoiding the drawbacks mentioned above.

The third feature is that the outside seams are covered with bias tape 120, 130, 230. This bias tape 120, 130, 230 provides a distinctive look to the bags 100, 200. Additionally, the bias tape 120, 130, 230 conceals and protects the outside stitching, thereby providing additional stability to the final assembly.

The fourth feature is that the stitches-per-inch (SPI) count is lower than what conventional wisdom teaches. Normally a higher stitch count (e.g., over ten (10) or twelve (12) SPI) means higher quality stitching for conventional canvas bags. However, for the inventive washable-paper bags 100, 200, seven (7) or eight (8) SPI is used to reduce the stitching holes in the paper. The reduced SPI increases stability and reduces the risk of tearing.

The fifth feature, which is optional (and shown in FIG. 7B), comprises straps that are attached using a box stitch, which adds strength to the straps. Preferably, the handles are attached using a Box-X Tacker on an industrial machine.

The sixth feature is thread denier, which, in one embodiment, is 40 denier polyester. Because substantially the same thread is used for canvas bags, the use of 40 denier thread requires no specialized tooling.

As will be appreciated by one skilled in the art, aspects of the present disclosure may be illustrated and described herein in any of a number of patentable classes or context including any new and useful process, machine, manufacture, or composition of matter, or any new and useful improvement thereof.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

What is claimed is:

1. A bag, comprising:
washable paper panels, consisting essentially of:
a substantially-rectangular side panel stitched at two (2) opposing ends to form a substantially-cylindrical structure, the substantially-cylindrical structure having a lower edge and an upper edge; and
a substantially-circular bottom panel stitched to the lower edge of the substantially-cylindrical structure to form a bucket-shaped structure;
seams, consisting essentially of:
a side seam stitching together the two (2) opposing ends of the substantially-rectangular side panel using a thread having a thread denier of 40, the side seam being located on the outside of the bucket-shaped structure, the side seam having a stitch count that is no greater than eight (8) stitches per inch (SPI); and
a bottom seam stitching together the lower edge of the substantially-cylindrical structure to the substantially-circular bottom panel using the thread having the thread denier of 40, the bottom seam being located on the outside of the bucket-shaped structure, the bottom seam having a stitch count that is no greater than eight (8) SPI;
a side bias tape substantially covering the side seam; and
a bottom bias tape substantially covering the bottom seam.

2. The bag of claim 1, further comprising a cuff formed by rolling the upper edge of the substantially-cylindrical structure.

3. The bag of claim 1, wherein each washable paper panel has an edge, and wherein at least one of the seams is stitched at approximately 0.25 inches from the edge.

4. The bag of claim 1, wherein the bucket-shaped structure has a height of approximately 12.5 inches, wherein the bucket-shaped structure further has a bottom diameter of approximately 9.5 inches.

5. A bag, comprising:
washable paper panels, consisting essentially of:
a substantially-rectangular side panel stitched at two (2) opposing ends, the side panel having a lower edge and an upper edge; and
a bottom panel stitched to the lower edge of the side panel; and
seams, comprising:
a side seam stitching together the two (2) opposing ends of the substantially-rectangular side panel; and
a bottom seam stitching together the lower edge of the substantially-rectangular side panel to the bottom panel.

6. The bag of claim 5, wherein the washable paper panels are comprise natural pulp fibers bonded with polymers.

7. The bag of claim 6, wherein each washable paper panel is Kraft-tex® paper, T484 (from Texon International Group, LTD).

8. The bag of claim 5, wherein the bottom panel is substantially circular.

9. The bag of claim 8, wherein the seams have a stitch count that is no greater than eight (8) stitches per inch (SPI).

10. The bag of claim 9, wherein the seams have a stitch count that is no greater than seven (7) stitches per inch (SPI).

11. The bag of claim 8, wherein the seams comprise threads having a thread denier of 40.

12. The bag of claim 8, wherein the seams are located outside of bag.

13. The bag of claim 12, further comprising:
a side bias tape covering the side seam; and
a bottom bias tape covering the bottom seam.

14. The bag of claim 5, wherein the bottom panel is substantially rectangular.

15. The bag of claim 14, wherein the seams have a stitch count that is no greater than eight (8) stitches per inch (SPI).

16. The bag of claim 14, further comprising:
handles box-stitched to the upper edge of the side panel.

17. The bag of claim 14, wherein the seams are located outside of bag.

18. The bag of claim 17, further comprising:
a side bias tape covering the side seam; and
a bottom bias tape covering the bottom seam.

19. The bag of claim 14, further comprising:
a pocket located on the side panel.

20. A process comprising the steps of:
stitching together two (2) opposing side edges of a side panel to form a stitched side edge, the stitching resulting in a structure having an upper edge and a lower edge;
covering the stitched side edge with a side bias tape;
stitching a bottom panel to the bottom edge of the structure to form a stitched bottom edge;
covering the stitched bottom edge with a bottom bias tape, the stitching and covering steps resulting in a washable paper bag;
inspecting the washable paper bag for quality control;
washing the washable paper bag; and
drying the washable paper bag.
